(19) United States
(12) Patent Application Publication
(10) Pub. No.: US 2007/0039445 A1
(43) Pub. Date: Feb. 22, 2007

(54) Wear resistant cutting blade

(76) Inventor: J. Leonard Nitsch, Syracuse, NY (US)

Correspondence Address: WALL MARJAMA & BILINSKI, 250 SOUTH CLINTON STREET, SUITE 300, SYRACUSE, NY, 13202, US

(21) Appl. No.: 11/207,314

(22) Filed: Aug. 19, 2005

(51) Int. Cl. B23D 57/00

(52) U.S. Cl. 83/835; 30/355

(57) ABSTRACT

A multi-purpose blade for cutting and slicing a wide variety of food products. The blade has a pair of opposed side surfaces that come together to establish a cutting edge that extends along the length of the blade. The cutting edge is scalloped to create a series of arcuate-shaped spans that are connected by wear resistant surfaces, each of which extends a given distance along the cutting edge. One or more pointed cutting teeth are located inside the boundaries of each arcuate span.

### FIELD OF THE INVENTION

This invention relates to a cutting blade, and, in particular, to a wear resistant blade for cutting and slicing a wide variety of food products.

### BACKGROUND OF THE INVENTION

A cutting blade is disclosed in U.S. Pat. No. 3,024,533 to Nitsch, which is well adapted for use in cutting and slicing many different types of foods. As set forth in the noted prior art patent, certain foods such as meats are best sliced using a smooth continuous cutting edge. Breads and other types of baked goods, on the other hand, have a texture which is best cut or sliced with a blade that has a scalloped or serrated cutting edge. Still other foods which are relatively coarser are best cut with a blade having sharp, pointed saw-like teeth. The cutting blade disclosed in the Nitsch patent contains a cutting edge that extends along the length of the blade. The cutting edge is scalloped to establish a series of primary sharp pointed teeth spaced apart along the blade. The primary teeth are separated by arcuate-shaped spans or cusps. A series of secondary pointed teeth are formed along the cutting edge inside the boundaries of each arcuate span. Accordingly, the disclosed blade is capable of effectively cutting and slicing a wide variety of food products of varying textures. The blade, however, tends to become worn rather quickly with usage and repeated sharpening. Wear predominantly occurs at the tips of the primary teeth reducing the length of the teeth and thus the effectiveness of the blade and shortens the usable life of the blade.

### SUMMARY OF THE INVENTION

It is therefore an object of the present invention to improve the wear resistance of a blade used to cut and slice a large variety of different food products.

A still further object of the present invention is to extend the usable life of a multiple purpose blade for cutting and slicing a wide variety of food products.

Another object of the present invention is to lengthen the time periods between which a multi-purpose food blade needs to be sharpened.

These and other objects of the current invention are attained by a multi-purpose blade that is well suited for effectively cutting and slicing a wide variety of food products. The blade has a pair of opposed side surfaces that are hollow ground downwardly from a given point on the blade to a cutting edge that extends along the length of the blade. The cutting edge is scalloped to establish a series of wear resistant surfaces that are co-joined by arcuate-shaped spans. One or more pointed cutting teeth are mounted inside the boundaries of each span.

### BRIEF DESCRIPTION OF THE DRAWINGS

For a better understanding of these and other objects of the present invention, reference can be made to the following detailed description of the invention which is to be read in association with the accompanying drawings, wherein:

FIG. 1 is a side elevation illustrating a generally linear cutting blade that embodies the teachings of the present invention;

FIG. 1A is a side elevation illustrating a circular cutting blade that embodies the teachings of the present invention;

FIG. 2 is an enlarged sectional view taken along lines 2-2 in FIG. 1;

FIG. 3 is an enlarged partial view taken along lines 3-3 in FIG. 2 showing one form of the blade cutting edge; and

FIG. 4 is an enlarged partial view taken along lines 4-4 in FIG. 2 showing a second form of the blade cutting edge.

### DETAILED DESCRIPTION OF THE INVENTION

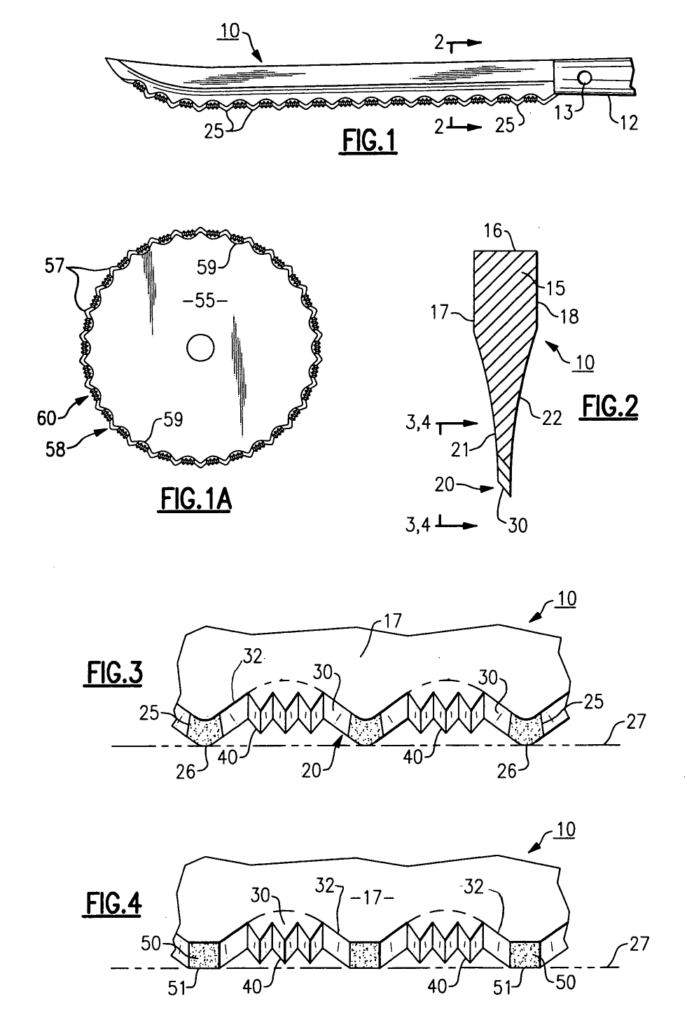

Referring initially to FIG. 1, there is illustrated an elongated knife blade, generally referenced 10, that embodies the teachings of the present invention. The blade is generally linear along its length and comes to a point at one end thereof. A tang (not shown) is integrally joined to the blade at the opposite end and the tang is slidably received within a slot formed within a handle 12. The handle is secured to the tang by means of a series of rivets 13 located along the central axis of the handle.

As further illustrated in FIG. 2, the blade contains a relatively thin body section 15 made of any suitable material. The blade includes a flat top surface 16 and two opposed parallel side surfaces 17 and 18. The bottom of the blade terminates with a cutting edge generally referenced 20. The lower section of each side of the blade is hollow ground as depicted in FIG. 2 at 21 and 22 with the hollow ground sections extending downwardly from a given vertical height to the cutting edge of the blade, thus providing a relatively fine cross section at the cutting edge.

With further reference to FIG. 3, the cutting edge 20 of the blade is scalloped to create a series of spaced apart wear surfaces 25-25 located along the length of the blade. The bottom edge 26 of each wear surface lies within a common plane 27. The cutting edge 20 of the blade contains a beveled surface 30 that follows the contour of the scalloped bottom edge and thus creates a curved shaped span 32 between each of the wear surfaces. As illustrated in FIG. 3, the wear surfaces are generally arcuate-shaped in form and thus, unlike the pointed teeth utilized in the above noted Nitsch patent, present an extended cutting edge to the product being cut or sliced. This, in turn, provides the blade with considerably more contact area than the prior art device, thus extending the usable life of the blade as well as the extent of the time periods between sharpening without adversely affecting the blade ability to cut or slice a wide variety of food products.

The cutting blade of the present invention includes a series of cutting teeth 40-40 located upon the cutting edge 20 of the blade inside each of the spans 32. The teeth are sharp pointed members which extend outwardly from the cutting edge 20 of the blade. The tips of the teeth, however, lie well inside the boundaries of the spans which are defined by the cutting edge 20 and the plane 27. Accordingly, the wear surfaces of the blade will initially create a kerf in the work piece that will be followed up by the pointed teeth 40 entering the kerf to complete the cut or slice. In this embodiment of the invention, three teeth are mounted within the boundaries of each span; however, the number of teeth utilized may vary without departing from the teachings of the present invention.

Turning now to FIG. 4, there is illustrated a further embodiment of the invention wherein like numerals are used to identify like parts described above. In this embodiment, the arcuate wear surfaces have been replaced with wear surfaces 50 each having a straight cutting edge 51. The straight cutting edges provide a little more contact area against the work and the sharp corners at both ends of the cutting edges increase the blade sawing action.

Although the present invention is ideally suited for use in association with straight edge cutting blades, it is equally well suited for use with a circular cutting disc such as a disc 55 illustrated in FIG. 1A. The outer cutting edge of the disc is scalloped to provide a series of spaced apart wear surfaces 57 having arcuate cutting edges 58 similar to the edges shown in FIG. 3. Each of the wear surfaces are co-joined to their neighbors by arcuate spans 59. The outer sections of the cutting edges of the wear surfaces in this case all lie upon a circular line that is centered upon the center of the disc. A series of sharp pointed teeth 60 are located within the boundaries of each span.

While this invention has been particularly shown and described with reference to the preferred embodiment in the drawings, it will be understood by one skilled in the art that various changes in its details may be effected therein without departing from the teachings of the invention.

What is claimed is:

1. An apparatus for cutting a variety of materials that includes:
a blade having a pair of opposed sides that come together to create a cutting edge along the length of the blade;
said cutting edge of the blade being scalloped to form a series of arcuate-shaped spans which are co-joined by wear surfaces each of which extend a given distance along the cutting edge; and
one or more pointed cutting teeth located within each of the arcuate-shaped spans, said teeth extending outwardly beyond the cutting edge of the blade with the tips of the teeth lying inside the boundaries of each span.

2. The apparatus of claim 1, wherein said blade is generally linear.

3. The apparatus of claim 1, wherein said blade is circular.

4. The apparatus of claim 1, wherein each extended wear surface has a straight cutting edge.

5. The apparatus of claim 1, wherein each extended wear surface has a curved cutting edge.

6. The apparatus of claim 1, wherein at least three cutting teeth are contained within each of said arcuate-shaped spans.

7. The apparatus of claim 1, wherein the sides of said blade are parallel along the upper portion of the blade height and are hollow ground along the lower portion of the blade to create a narrow cutting edge.
